(19) United States
(12) Patent Application Publication
(10) Pub. No.: US 2006/0146270 A1
(43) Pub. Date: Jul. 6, 2006

(54) OCB mode transflective liquid crystal display device

(75) Inventors: Chiu-Lien Yang, Miao-Li (TW); Rui-Jie Xiang, Miao-Li (TW); Wei-Yi Ling, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/320,045

(22) Filed: Dec. 28, 2005

(30) Foreign Application Priority Data
Dec. 30, 2004 (CN) 200410091951.0

(51) Int. Cl. C09K 19/02

(52) U.S. Cl. 349/177

(57) ABSTRACT

An LCD device (10) includes a first substrate (22), a second substrate (21), and a liquid crystal layer (23) including bend-aligned liquid crystal molecules interposed between the first and second substrates. The liquid crystal display device operates in an optically compensated bend (OCB) mode. The LCD device includes a plurality of pixel regions defining reflection and transmission regions (232, 231). A thickness of the liquid crystal layer in the reflection regions is less than a thickness of the liquid crystal layer in the transmission regions. Preferably, the liquid crystal display device further includes quarter-wave plates as first upper and lower retardation films (521, 511) disposed at outer surfaces of the first and second substrates. This ensures that the LCD device provides a quality display image and that its liquid crystal molecules can be realigned in a very short time upon a change in the applied electric field.

### FIELD OF THE INVENTION

The present invention relates to liquid crystal display (LCD) devices that operate in OCB (optically compensated bend) mode, and more particularly to a reflection/transmission type LCD device capable of providing a display both in a reflection mode and a transmission mode.

### GENERAL BACKGROUND

Among LCD products, there have been the following three types of LCD devices commercially available: a reflection type LCD device utilizing ambient light, a transmission type LCD device utilizing backlight, and a semi-transmission type LCD device equipped with a half mirror and a backlight.

With a reflection type LCD device, a display becomes less visible in a poorly lit environment. In contrast, a display of a transmission type LCD device appears hazy in strong ambient light (e.g., outdoor sunlight). Thus researchers sought to provide an LCD device capable of functioning in both modes so as to yield a satisfactory display in any environment. In due course, a semi-transmission type LCD device was disclosed in Japanese Laid-Open Publication No. 7-333598.

However, the above-mentioned semi-transmission type LCD device typically has the following problems.

The semi-transmission type LCD device uses a half mirror instead of the reflective plate used in a reflection type LCD device, and has a minute transmission region (e.g., minute holes in a thin metal film) in a reflection region, thereby providing a display by utilizing transmitted light as well as reflected light. Since both the reflected light and the transmitted light used for the display pass through the same liquid crystal layer of the LCD device, an optical path of the reflected light is twice as long as that of the transmitted light. This causes a large difference in the retardation of the liquid crystal layer with respect to the reflected light and the transmitted light. Thus, a satisfactory display image cannot be obtained. Furthermore, the means for providing both a reflection mode and a transmission mode for the display are superimposed on each other, so that the respective modes cannot be separately optimized. This results in difficulty in providing a quality color display image, and tends to cause a blurred display image as well.

What is needed, therefore, is a liquid crystal display device that overcomes the above-described deficiencies.

### SUMMARY

In a preferred embodiment, a liquid crystal display (LCD) device includes a first substrate and a second substrate. A liquid crystal layer having liquid crystal molecules is interposed between the first and second substrates, and the liquid crystal molecules are bend-aligned to cause the liquid crystal display device to operate in an optically compensated bend (OCB) mode. The LCD device includes a plurality of pixel regions. Each pixel region defines a reflection region and a transmission region, and a thickness of the liquid crystal layer in the reflection region is less than a thickness of the liquid crystal layer in the transmission region.

Further, the LCD device preferably includes a first upper retardation film and a second upper retardation film disposed at an outer surface of the first substrate. Preferably, the first and second upper retardation films are quarter-wave plates.

According to other embodiments, the LCD device may further include any one or combination of a first compensation layer disposed between the first upper retardation film and the first substrate, and a second compensation layer disposed between the first lower retardation film and the second substrate.

In certain of various embodiments of the LCD device, the retardation films and the compensation layers compensate for color in both the reflection region and the transmission region of each of the pixel regions, in order to improve the characteristics of contrast and viewing angle. This helps ensure that the LCD device provides a good quality display image. In addition, the alignment and the pre tilt angles of the liquid crystal molecules ensure that the liquid crystal molecules are aligned in a very short time upon a change in a driving electric field.

Other advantages and novel features will become more apparent from the following detailed description when taken in conjunction with the accompanying drawings.

### BRIEF DESCRIPTION OF THE DRAWINGS

FIG. 1 is a schematic, exploded, side cross-sectional view of part of an LCD device according to a first embodiment of the present invention.

FIG. 2 is a schematic, exploded, side cross-sectional view of part of an LCD device according to a second embodiment of the present invention.

FIG. 3 is a schematic, exploded, side cross-sectional view of part of an LCD device according to a third embodiment of the present invention.

FIG. 4 is a schematic, exploded, side cross-sectional view of part of an LCD device according to a fourth embodiment of the present invention.

FIG. 5 shows a polarized state of light in each of certain layers of the LCD device of FIG. 4, in respect of an on-state (white state) and an off-state (black state) of the LCD device, when the LCD device operates in a reflection mode.

FIG. 6 shows a polarized state of light in each of certain layers of the LCD device of FIG. 4, in respect of an on-state (white state) and an off-state (black state) of the LCD device, when the LCD device operates in a transmission mode.

FIG. 7 is a schematic, exploded, side cross-sectional view of part of an LCD device according to a fifth embodiment of the present invention.

### DETAILED DESCRIPTION OF PREFERRED EMBODIMENTS

FIG. 1 is a schematic, exploded, side cross-sectional view of part of an LCD device 10 according to a first embodiment of the present invention. The LCD device 10 includes a first substrate 22, a second substrate 21 disposed parallel to and spaced apart from the first substrate 22, and a liquid crystal layer 23 having liquid crystal molecules (not labeled) sandwiched between the substrates 22 and 21.

A first upper retardation film 521, a second upper retardation film 522, and a first polarizer 32 are disposed in that order on an outer surface of the first substrate 22. A first lower retardation film 511, a second lower retardation film 512, and a second polarizer 31 are disposed in that order on an outer surface of the second substrate 21.

In this embodiment, the first upper and first lower retardation films 521, 511 are quarter-wave plates, and the second upper and second lower retardation films 522, 512 are half-wave plates. The first polarizer 32 has a polarizing axis perpendicular to a polarizing axis of the second polarizer 31, and the first upper retardation film 521 has an optical axis perpendicular to an optical axis of the first lower retardation film 511.

An optical axis of the second upper retardation film 522 maintains an angle θ₁ relative to the polarizing axis of the first polarizer 32, and the optical axis of the first upper retardation film 521 maintains an angle of 2θ₁±45° relative to the polarizing axis of the first polarizer 32. The angle θ₁ is in a range of 8° to 22° or in a range of 68° to 82°. An optical axis of the second lower retardation film 512 maintains an angle θ₂ relative to the polarizing axis of the second polarizer 31, and the optical axis of the first lower retardation film 511 maintains an angle of 2θ₂±45° relative to the polarizing axis of the second polarizer 31. The angle θ₂ is in a range of 8° to 22° or in a range of 68° to 82°.

A transparent common electrode 221 and a first alignment film 42 are disposed in that order on an inner surface of the first substrate 22. The common electrode 221 is made of a transparent conductive material such as indium-tin-oxide (ITO) or indium-zinc-oxide (IZO).

A plurality of transmission electrodes 46 and a plurality of reflection electrodes 45 are disposed on an inner surface of the second substrate 21. In accordance with an exemplary embodiment of the present invention, the transmission electrodes 46 are made of a transparent conductive material such as indium-tin-oxide (ITO) or indium-zinc-oxide (IZO), and the reflection electrodes 45 are made of metal with a high reflective ratio such as aluminum (Al). A second alignment film 41 is disposed on the transmission and reflection electrodes 46, 45. A passivation layer 25 is disposed between the reflection electrodes 45 and the second substrate 21.

The liquid crystal layer 23, the common electrode 221, the transmission electrodes 46, and the reflection electrodes 45 cooperatively define a plurality of pixel regions. Each pixel region includes a reflection region 232 corresponding to a respective reflection electrode 45, and a transmission region 231 corresponding to a respective transmission electrode 46. When a voltage is applied to the LCD device 10, an electric field is generated between the common electrode 221, the transmission electrodes 46, and the reflection electrodes 45. The electric field can control the orientation of the liquid crystal molecules in order to display images.

The pixel regions include the transmission regions 231 and reflection regions 232. The liquid crystal molecules are bend-aligned to cause the liquid crystal display device to operate in an optically compensated bend (OCB) mode. A pretilt angle of the liquid crystal molecules adjacent to the substrates 21 and 22 is in a range of 0° to 15°. A thickness of the liquid crystal layer 23 in the reflection regions 232 is less than a thickness of the liquid crystal layer in the transmission regions 231.

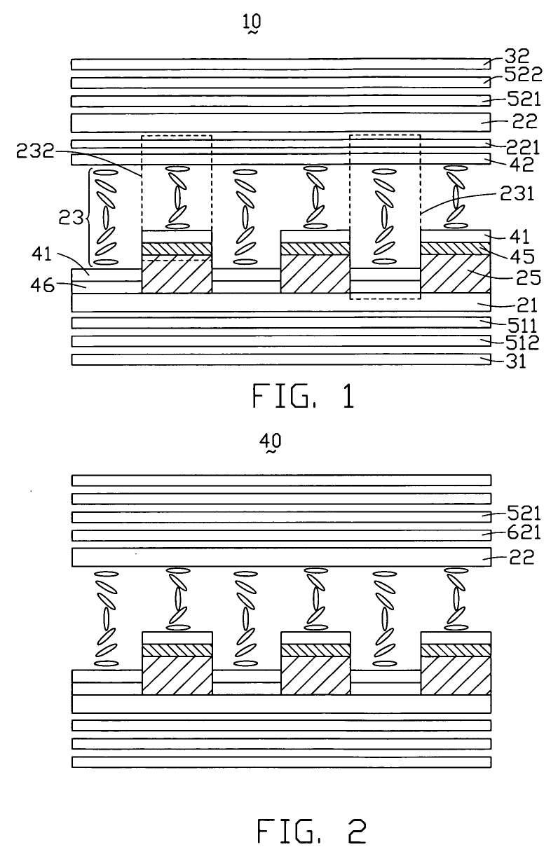

FIG. 2 is a schematic, exploded, side cross-sectional view of part of an LCD device 40 according to a second embodiment of the present invention. The LCD device 40 is similar to the LCD device 10 of FIG. 1. However, the LCD device 40 includes a compensation layer 621 disposed between the first upper retardation film 521 and the first substrate 22.

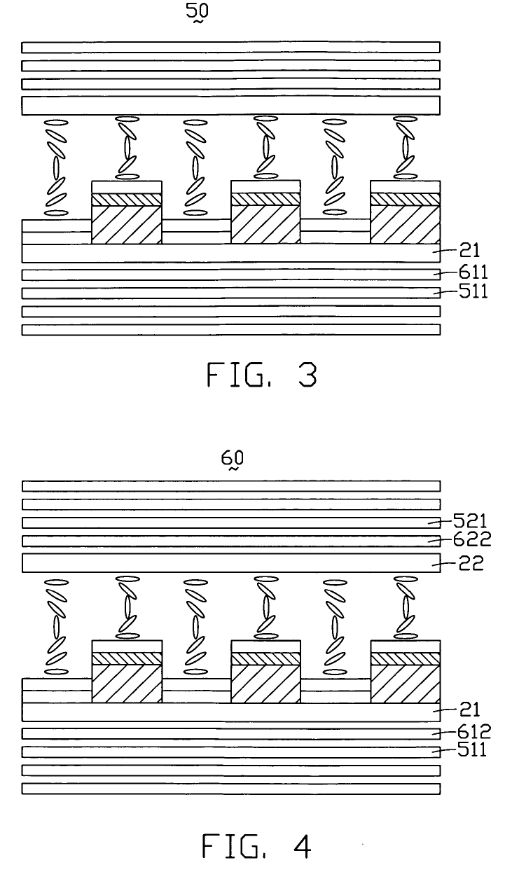

FIG. 3 is a schematic, exploded, side cross-sectional view of part of an LCD device 50 according to a third embodiment of the present invention. The LCD device 50 is similar to the LCD device 10 of FIG. 1. However, the LCD device 50 includes a compensation layer 611 disposed between the first lower retardation film 511 and the second substrate 21.

FIG. 4 is a schematic, exploded, side cross-sectional view of part of an LCD device 60 according to a fourth embodiment of the present invention. The LCD device 60 is similar to the LCD device 10 of FIG. 1. However, the LCD device 60 includes a first compensation layer 622 disposed between the first upper retardation film 521 and the first substrate 22, and a second compensation layer 612 disposed between the first lower retardation film 511 and the second substrate 21. Optical axes of the first compensation layer 622 and the second compensation layer 612 are parallel to a rubbing direction of the first and second substrates 22, 21.

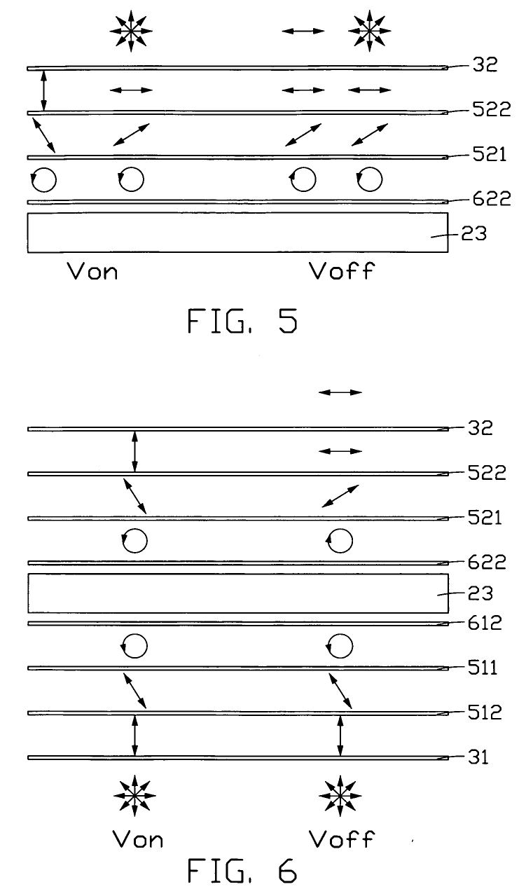

FIG. 5 shows a polarized state of light in each of certain layers of the LCD device 60 of FIG. 4, in respect of an on-state (white state) and an off-state (black state) of the LCD device 60 when the LCD device 60 operates in a reflection mode. When no voltage is applied to the LCD device 60, the LCD device 60 is in an on-state. The linearly-polarized light passes through the second upper retardation film 522 (a half-wave plate). The polarized state of the linearly-polarized light is not changed, and the polarizing direction thereof twists by an amount of 2θ. Thereafter, the linearly-polarized light is incident upon the first upper retardation film 521 (a quarter-wave plate), and becomes circularly-polarized light. Then the circularly-polarized light passes through the first compensation layer 622 and is incident upon the liquid crystal layer 23. Since an effective phase difference of the liquid crystal layer 23 in an on-state is adjusted to a wavelength of λ/4 in order to obtain a white display, the incident circularly-polarized light becomes linearly-polarized light. The linearly-polarized light exiting the liquid crystal layer 23 is reflected by the reflection electrodes 45. The linearly-polarized light keeps its polarized state, and is incident on the liquid crystal layer 23 again. The linearly-polarized light passing through the liquid crystal layer 23 becomes circularly-polarized light having a polarizing direction opposite to that of the circularly-polarized light originally incident on the liquid crystal layer 23. The circularly-polarized light exiting the liquid crystal layer 23 is converted to linearly-polarized light by the quarter-wave plate 521. Thereafter, the linearly-polarized light passes through the half-wave plate 522, and is output through the first polarizer 32 for displaying images.

On the other hand, when a voltage is applied to the LCD device 10, the LCD device 10 is in an off-state. Up to the point where ambient incident light reaches the liquid crystal layer 23, the ambient incident light undergoes transmission in substantially the same way as described above in relation to the LCD device 10 being in the on-state. Since an effective phase difference of the liquid crystal layer 23 is adjusted to be 0 by applying a voltage in order to obtain a black display, the circularly-polarized light incident on the liquid crystal layer 23 passes therethrough as circularly-polarized light. The circularly-polarized light exiting the liquid crystal layer 23 is reflected by the reflection electrodes 45. The circularly-polarized light keeps its polarized state, and is incident on the liquid crystal layer 23 again. After passing through the liquid crystal layer 23, the circularly-polarized light is converted into linearly-polarized light by the first upper retardation film 521 (a quarter-wave plate). At this time, the polarizing direction of the linearly-polarized light is rotated by about 90° compared with that of a white display state. Thus the linearly-polarized light is not output from the LCD device 60 for displaying images.

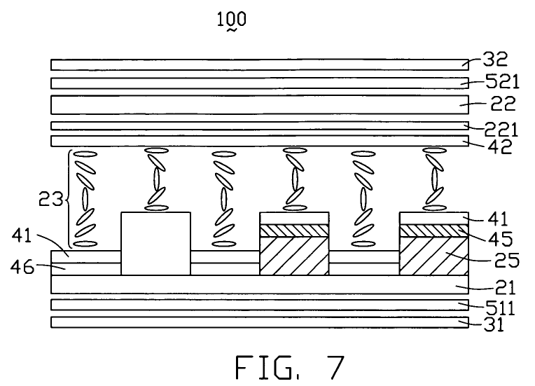

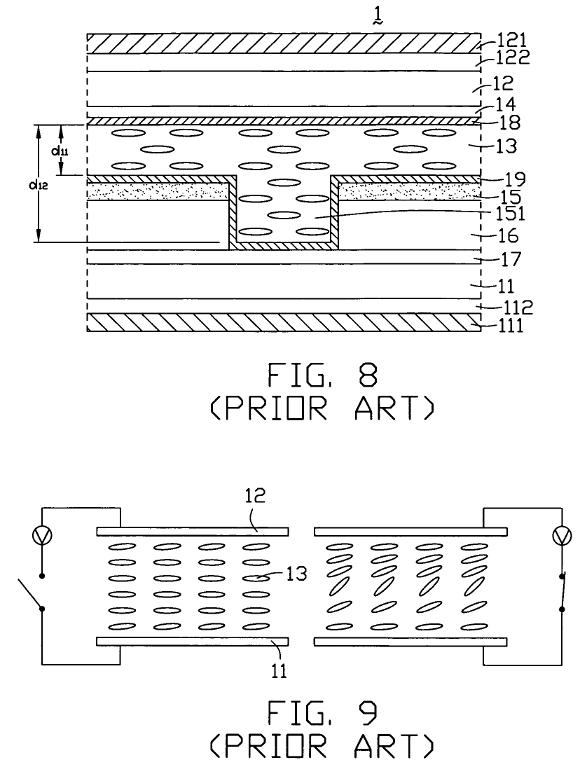

FIG. 6 shows a polarized state of light in each of certain layers of the LCD device 60 of FIG. 4, in respect of an on-state (white state) and an off-state (black state) of the LCD device 60 when the LCD device 60 operates in a transmission mode. Incident light undergoes transmission in a manner similar to that described above in relation to the LCD device 60 operating in the reflection mode. The circularly-polarized light passes through the second compensation layer 612 before it is incident on the liquid crystal layer 23. The second compensation layer 612 functions in like manner to the first compensation layer 622.

In each pixel region of the LCD device 60, the liquid crystal molecules have a pre-tilt angle, which ensures that the liquid crystal molecules can more easily adjust their orientation when a voltage is applied to the LCD device 60 and a change in a driving electric field is effected. Thereby, the LCD device 60 has a fast response time. Moreover, the retardation films and the compensation layers are used for compensating for color, so as to ensure that the LCD device 60 displays a good quality image and improve the characteristics of contrast and viewing angle.

FIG. 7 is a schematic, exploded, side cross-sectional view of part of an LCD device 100 according to a fifth embodiment of the present invention. The LCD device 100 is similar to the LCD devices 10, 40, 50, 60 of FIG. 1 through FIG. 4. The difference between the LCD device 100 and the LCD devices 10, 40, 50, 60 is that in the LCD device 100, the second upper and second lower retardation films 522 and 512 are omitted.

Various modifications and alterations are possible within the ambit of the invention herein. For example, the compensation layers may be biaxial compensation films, single compensation films, A-plate compensation films, or discotic molecular films. In addition, the LCD device may employ only a single compensation layer disposed on either the first substrate or on the second substrate. Furthermore, any or all of the retardation films and the compensation layers may be disposed on or at inner surfaces of either of the first and second substrates.

It is to be further understood that even though numerous characteristics and advantages of the present embodiments have been set out in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A liquid crystal display device, comprising:
a first substrate and a second substrate;
a liquid crystal layer having liquid crystal molecules interposed between the first and second substrates, the liquid crystal molecules being bend-aligned to cause the liquid crystal display device to operate in an optically compensated bend (OCB) mode; and
a plurality of pixel regions, each of the pixel regions defining a reflection region and a transmission region, wherein a thickness of the liquid crystal layer in the reflection region is less than a thickness of the liquid crystal layer in the transmission region.

2. The liquid crystal display device as claimed in claim 1, wherein a pre tilt angle of liquid crystal molecules adjacent to the first and second substrates is in a range of 0° to 15°.

3. The liquid crystal display device as claimed in claim 2, further comprising a plurality of reflection electrodes disposed at an inner surface of the second substrate corresponding to the reflection regions.

4. The liquid crystal display device as claimed in claim 3, further comprising a passivation layer disposed between the reflection electrodes and the second substrate.

5. The liquid crystal display device as claimed in claim 1, further comprising a first alignment layer and a second alignment layer respectively disposed between the liquid crystal layer and the first and second substrates.

6. The liquid crystal display device as claimed in claim 1, further comprising a first polarizer and a second polarizer respectively provided at outer sides of the first and second substrates.

7. The liquid crystal display device as claimed in claim 6, further comprising a first upper retardation film disposed between the first polarizer and the first substrate, and a first lower retardation film disposed between the second polarizer and the second substrate.

8. The liquid crystal display device as claimed in claim 7, wherein the first upper and first lower retardation films are quarter-wave plates.

9. The liquid crystal display device as claimed in claim 8, wherein polarizing axes of the first and second polarizers are perpendicular to each other, and optical axes of the first upper and first lower retardation films are perpendicular to each other.

10. The liquid crystal display device as claimed in claim 7, further comprising a first compensation layer disposed between the first upper retardation film and the first substrate, and a second compensation layer disposed between the first lower retardation film and the second substrate.

11. The liquid crystal display device as claimed in claim 10, wherein optical axes of the first compensation layer and the second compensation layer are parallel to a rubbing direction of the first and second substrates.

12. The liquid crystal display device as claimed in claim 10, wherein the first compensation layer and the second compensation layer are discotic molecular films.

13. The liquid crystal display device as claimed in claim 7, further comprising a second upper retardation film disposed between the first polarizer and the first upper retardation film, and a second lower retardation film disposed between the second polarizer and the first lower retardation film.

14. The liquid crystal display device as claimed in claim 13, wherein the second upper and second lower retardation films are half-wave plates.

15. The liquid crystal display device as claimed in claim 14, wherein a pre tilt angle of liquid crystal molecules in the transmission regions adjacent to the substrates is in a range of 0° to 15°.

16. The liquid crystal display device as claimed in claim 13, further comprising a first compensation layer disposed between the first upper retardation film and the first substrate, and a second compensation layer disposed between the first lower retardation film and the second substrate.

17. The liquid crystal display device as claimed in claim 16, wherein the first compensation layer and the second compensation layer are A-plate compensation films.

18. The liquid crystal display device as claimed in claim 13, wherein an optical axis of the second upper retardation film maintains an angle θ₁ relative to a polarizing axis of the first polarizer, and an optical axis of the first upper retardation film maintains an angle of 2θ₁±45° relative to the polarizing axis of the first polarizer.

19. The liquid crystal display device as claimed in claim 18, wherein θ₁ is in a range of 8° to 22° or in a range of 68° to 82°.

20. The liquid crystal display device as claimed in claim 18, wherein an optical axis of the second lower retardation film maintains an angle θ₂ relative to a polarizing axis of the second polarizer, and an optical axis of the first lower retardation film maintains an angle of 2θ₂±45° relative to the polarizing axis of the second polarizer.

21. The liquid crystal display device as claimed in claim 20, wherein θ₂ is in a range of 8° to 22° or in a range of 68° to 82°.

22. The liquid crystal display device as claimed in claim 20, wherein optical axes of the first and second polarizers are perpendicular to each other, optical axes of the first upper and first lower retardation films are perpendicular to each other, and optical axes of the second upper and second lower retardation films are perpendicular to each other.
